(19) United States
(12) Patent Application Publication
(10) Pub. No.: US 2025/0320996 A1
(43) Pub. Date: Oct. 16, 2025

(54) METHODS AND DEVICES FOR CONTROLLING STEAM INTRODUCTION IN A KILN

(71) Applicant: Group14 Technologies, Inc., Woodinville, WA (US)

(72) Inventors: Adam Vidoni, Woodinville, WA (US); Michael S. Smith, Sammamish, WA (US); Frank Bruneel, Moses Lake, WA (US); Christopher Klein, Kenmore, WA (US)

(21) Appl. No.: 19/015,006

(22) Filed: Jan. 9, 2025

Related U.S. Application Data
(60) Provisional application No. 63/620,053, filed on Jan. 11, 2024.

(51) Int. Cl. F22B 35/06; F22B 37/14

(52) U.S. Cl. CPC F22B 35/06; F22B 37/14

(57) ABSTRACT

Methods and systems for controlling steam distribution within a kiln. A kiln system includes a muffle, a boiler, a steam sparger coupled to the boiler and located with the muffle. The steam sparger is configured to output steam at a proximal end that is different from output steam at a distal end by less than a threshold amount, and a material introduction device configured to move material from a proximal end to a distal of the muffle, the material introduction device located a predefined distance from the steam sparger.

### CROSS REFERENCE TO RELATED APPLICATION

This application claims priority to U.S. Provisional Application No. 63/620,053, filed Jan. 11, 2024, the entirety of which is incorporated by reference in its entirety.

### BACKGROUND

Introduction of steam within a kiln muffle can be difficult to control. Typically, the steam exiting a sparger closer to the steam source will be of greater quantity than the steam exiting the sparger further away from the steam source. Thus, this inconsistent steam stream makes it more difficult to control exposure of material passing through the kiln.

### BRIEF SUMMARY

Various disclosed embodiments include illustrative systems and methods for creating carbon particles and electrochemical modifier infiltrated carbon particles. In certain embodiments the electrochemical modifier comprises at least one Group 14 element (e.g., carbon or silicon).

In an illustrative embodiment, a kiln system including a muffle, a boiler, a steam sparger coupled to the boiler and located with the muffle, wherein the steam sparger is configured to output steam at a proximal end that is different from output steam at a distal end by less than a threshold amount, and a material introduction device configured to move material from a proximal end to a distal of the muffle, the material introduction device located a predefined distance from the steam sparger.

In another illustrative embodiment, a muffle device including a steam sparger configured to receive steam from a boiler, wherein the steam sparger is configured to output steam at a proximal end that is different from output steam at a distal end by less than a threshold amount and a material introduction device configured to move material from a proximal end to a distal of the muffle device, the material introduction device located a predefined distance from the steam sparger.

In still another illustrative embodiment, an activated carbon generating system including a kiln configured to produced activated carbon material, the kiln including a muffle, a boiler, a steam sparger coupled to the boiler and located with the muffle, wherein the steam sparger is configured to output steam at a proximal end that is different from output steam at a distal end by less than a threshold amount, and a carbon material transport device configured to move pyrolyzed carbon material from a proximal end to a distal of the muffle, the carbon material introduction device located a predefined distance from the steam sparger.

### BRIEF DESCRIPTION OF THE DRAWINGS

FIG. 1 is a top view of a kiln device formed in accordance with an embodiment of the present invention.

FIG. 2 is a side view of the kiln device shown in FIG. 1.

FIG. 3 is a bottom view of a sparger used in the kiln device of FIG. 1 formed in accordance with an embodiment of the present invention.

FIG. 4 is a bottom view of a sparger used in the kiln device of FIG. 1 formed in accordance with another embodiment of the present invention.

FIG. 5 is a bottom view of a sparger used in the kiln device of FIG. 1 formed in accordance with a further embodiment of the present invention.

FIG. 6 is a bottom view of sparger components used in the kiln device of FIG. 1 formed in accordance with a further embodiment of the present invention.

FIG. 7 is a process for creating a sparger formed in accordance with an embodiment of the present invention.

### DETAILED DESCRIPTION

In the following description, certain specific details are set forth in order to provide a thorough understanding of various embodiments. However, one skilled in the art will understand that the disclosure may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed disclosure.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

### A. Porous Scaffold Materials

For the purposes of embodiments of the current disclosure, a porous scaffold may be used, into which one or more electrochemical modifier (e.g., lithium or silicon) is to be impregnated. In this context, the porous scaffold can comprise various materials. In some embodiments the porous scaffold material primarily comprises carbon, for example hard carbon. Other allotropes of carbon are also envisioned in other embodiments, for example, graphite, amorphous carbon, diamond, C60, carbon nanotubes (e.g., single and/or multi-walled), graphene and/or carbon fibers. The introduction of porosity into the carbon material can be achieved by a variety of means. For instance, the porosity in the carbon material can be achieved by modulation of polymer precursors, and/or processing conditions to create said porous carbon material, and described in detail in the subsequent section.

In other embodiments, the porous scaffold comprises a polymer material. To this end, a wide variety of polymers are envisioned in various embodiments to have utility, including, but not limited to, inorganic polymers, organic polymers, and additional polymers. Examples of organic polymers includes, but are not limited to, sulfur-containing polymers such polysulfides and polysulfones, low density polyethylene (LDPE), high density polyethylene (HDPE), polypropylene (PP), polyvinyl chloride (PVC), polystyrene (PS), nylon, nylon 6, nylon 6,6, teflon (Polytetrafluoroethylene), thermoplastic polyurethanes (TPU), polyureas, poly(lactide), poly(glycolide) and combinations thereof, phenolic resins, polyamides, polyaramids, polyethylene terephthalate, polychloroprene, polyacrylonitrile, polyaniline, polyimide, poly(3,4-ethylenedioxythiophene) polystyrene sulfonate (PDOT: PSS), polymerized polydivinylbenzene, and others known in the arts. The organic polymer can be synthetic or natural in origin. In some embodiments, the polymer is a polysaccharide, such as sucrose, starch, cellulose, cellobiose, amylose, amylopectin, gum Arabic, lignin, and the like. In some embodiments, the polysaccharide is derived from the caramelization of mono-or oligomeric sugars, such as fructose, glucose, sucrose, maltose, raffinose, and the like.

In certain embodiments, the porous scaffold polymer material comprises a coordination polymer. Coordination polymers in this context include, but are not limited to, metal organic frameworks (MOFs). Techniques for production of MOFs, as well as exemplary species of MOFs, are known and described in the art (“The Chemistry and Applications of Metal-Organic Frameworks, Hiroyasu Furukawa et al. Science 341, (2013); DOI: 10.1126/science.1230444). Examples of MOFs in the context include, but are not limited to, Basolite™ materials and zeolitic imidazolate frameworks (ZIFs).

Concomitant with the myriad variety of polymers envisioned with the potential to provide a porous substrate, various processing approaches are envisioned in various embodiments to achieve said porosity. In this context, general methods for imparting porosity into various materials are myriad, as known in the art, including, but certainly not limited to, methods involving emulsification, micelle creation, gasification, dissolution followed by solvent removal (for example, lyophilization), axial compaction and sintering, gravity sintering, powder rolling and sintering, isostatic compaction and sintering, metal spraying, metal coating and sintering, metal injection molding and sintering, and the like. Other approaches to create a porous polymeric material, including creation of a porous gel, such as a freeze-dried gel, aerogel, and the like are also envisioned.

In certain embodiments, the porous scaffold material comprises a porous ceramic material. In certain embodiments, the porous scaffold material comprises a porous ceramic foam. In this context, general methods for imparting porosity into ceramic materials are varied, as known in the art, including, but certainly not limited to, creation of porous In this context, general methods and materials suitable for comprising the porous ceramic include, but are not limited to, porous aluminum oxide, porous zirconia toughened alumina, porous partially stabilized zirconia, porous alumina, porous sintered silicon carbide, sintered silicon nitride, porous cordierite, porous zirconium oxide, clay-bound silicon carbide, and the like.

In certain embodiments, the porous material comprises a porous metal. Suitable metals in this regard include, but are not limited to porous aluminum, porous steel, porous nickel, porous Inconcel, porous Hastelloy, porous titanium, porous copper, porous brass, porous gold, porous silver, porous germanium, and other metals capable of being formed into porous structures, as known in the art. In some embodiments, the porous scaffold material comprises a porous metal foam. The types of metals and methods to manufacture related to the same are known in the art. Such methods include, but are not limited to, casting (including foaming, infiltration, and lost-foam casting), deposition (chemical and physical), gas-eutectic formation, and powder metallurgy techniques (such as powder sintering, compaction in the presence of a foaming agent, and fiber metallurgy techniques).

### B. Porous Carbon Scaffold Materials

Methods for preparing porous carbon materials from polymer precursors are known in the art. For example, methods for preparation of carbon materials are described in U.S. Pat. Nos. 7,723,262, 8,293,818, 8,404,384, 8,654,507, 8,916,296, 9,269,502, 10,590,277, and 10,711,140, the full disclosures of which are hereby incorporated by reference in their entireties for all purposes.

Accordingly, in one embodiment the present disclosure provides a method for preparing any of the carbon materials or polymer gels described above. The method may be performed by the porous carbon production system 22. The carbon materials may be synthesized through pyrolysis of either a single precursor, for example a saccharide material such as sucrose, fructose, glucose, dextrin, maltodextrin, starch, amylopectin, amylose, lignin, gum Arabic, and other saccharides known in the art, and combinations thereof. Alternatively, the carbon materials may be synthesized through pyrolysis of a complex resin, for instance formed using a sol-gel method using polymer precursors such as phenol, resorcinol, bisphenol A, urea, melamine, and other suitable compounds known in the art, and combinations thereof, in a suitable solvent such as water, ethanol, methanol, and other solvents known in the art, and combinations thereof, with cross-linking agents such as formaldehyde, hexamethylenetetramine, furfural, and other cross-linking agents known in the art, and combinations thereof. The resin may be acid or basic, and may contain a catalyst. The catalyst may be volatile or non-volatile. The pyrolysis temperature and dwell time can vary as known in the art.

In some embodiments, the methods comprise preparation of a polymer gel by a sol gel process, condensation process or crosslinking process involving monomer precursor(s) and a crosslinking agent, two existing polymers and a crosslinking agent or a single polymer and a crosslinking agent, followed by pyrolysis of the polymer gel. The polymer gel may be dried (e.g., freeze dried) prior to pyrolysis; however drying is not necessarily required.

The target carbon properties can be derived from a variety of polymer chemistries provided the polymerization reaction produces a resin/polymer with the necessary carbon backbone. Different polymer families include novolacs, resoles, acrylates, styrenes, urethanes, rubbers (neoprenes, styrene-butadienes, etc.), nylons, etc. The preparation of any of these polymer resins can occur via a number of different processes including sol gel, emulsion/suspension, solid state, solution state, melt state, etc. for either polymerization and crosslinking processes.

In some embodiments the reactant comprises phosphorus. In certain other embodiments, the phosphorus is in the form of phosphoric acid. In certain other embodiments, the phosphorus can be in the form of a salt, wherein the anion of the salt comprises one or more phosphate, phosphite, phosphide, hydrogen phosphate, dihydrogen phosphate, hexafluorophosphate, hypophosphite, polyphosphate, or pyrophosphate ions, or combinations thereof. In certain other embodiments, the phosphorus can be in the form of a salt, wherein the cation of the salt comprises one or more phosphonium ions. The non-phosphate containing anion or cation pair for any of the above embodiments can be chosen for those known and described in the art. In the context, exemplary cations to pair with phosphate-containing anions include, but are not limited to, ammonium, tetraethylammonium, and tetramethylammonium ions. In the context, exemplary anions to pair with phosphate-containing cations include, but are not limited to, carbonate, dicarbonate, and acetate ions.

In some embodiments, the reactant comprises sulfur. In certain other embodiments, the sulfur is in the form of sulfuric acid. In certain other embodiments, the sulfur can be in the form of a salt, wherein the anion of the salt comprises one or more sulfate, sulfite, bisulfide, bisulfite, hypothiocyanite, sulfonium, S-methylmethionine, thiocarbonate, thiocyanate, thiophosphate, thiosilicate, or trimethylsulfonium, or combinations thereof.

In some embodiments, the catalyst comprises a basic volatile catalyst. For example, in one embodiment, the basic volatile catalyst comprises ammonium carbonate, ammonium bicarbonate, ammonium acetate, ammonium hydroxide, or combinations thereof. In a further embodiment, the basic volatile catalyst is ammonium carbonate. In another further embodiment, the basic volatile catalyst is ammonium acetate.

In still other embodiments, the method comprises admixing an acid. In certain embodiments, the acid is a solid at room temperature and pressure. In some embodiments, the acid is a liquid at room temperature and pressure. In some embodiments, the acid is a liquid at room temperature and pressure that does not provide dissolution of one or more of the other polymer precursors.

In one embodiment a spherical polydivinylbencene spheres are produced by precipitation polymerization, pyrolyzed, and activated by the methods described herein.

In one embodiment, a porous carbon can be prepared by pyrolysis of a fluorine containing polymer (e.g., polyvinylidenine fluoride) by heating the material to 600° C. under an inerting gas such as nitrogen flowing in a horizontal tube furnace. The material was allowed to cool for 30 minutes and subsequently cooled at room departure prior to removing from the furnace. The resulting carbonized material was attrition milled to less than 25-micron particle size distribution and used to prepare electrodes. The porous carbon prepared by this method is rich in fluorine which facilitates formation of lithium fluoride in the initial stage of electrochemical plating of the lithium metal in a lithium ion battery, thereby increasing the lithiophilicity and reduces detrimental dendrite growth in the battery.

In certain embodiments, the polymer precursor components are blended together and subsequently held for a time and at a temperature sufficient to achieve polymerization. One or more of the polymer precursor components can have particle size less than about 20 mm in size, for example less than 10 mm, for example less than 7 mm, for example, less than 5 mm, for example less than 2 mm, for example less than 1 mm, for example less than 100 microns, for example less than 10 microns. In some embodiments, the particle size of one or more of the polymer precursor components is reduced during the blending process.

The blending of one or more polymer precursor components in the absence of solvent can be accomplished by methods described in the art, for example ball milling, jet milling, Fritsch milling, planetary mixing, and other mixing methodologies for mixing or blending solid particles while controlling the process conditions (e.g., temperature). The mixing or blending process can be accomplished before, during, and/or after (or combinations thereof) incubation at the reaction temperature.

Reaction parameters include aging the blended mixture at a temperature and for a time sufficient for the one or more polymer precursors to react with each other and form a polymer. In this respect, suitable aging temperature ranges from about room temperature to temperatures at or near the melting point of one or more of the polymer precursors. In some embodiments, suitable aging temperature ranges from about room temperature to temperatures at or near the glass transition temperature of one or more of the polymer precursors. For example, in some embodiments the solvent free mixture is aged at temperatures from about 20° C. to about 600° C., for example about 20° C. to about 500° C., for example about 20° C. to about 400° C., for example about 20° C. to about 300° C., for example about 20° C. to about 200° C. In certain embodiments, the solvent free mixture is aged at temperatures from about 50 to about 250° C.

The reaction duration is generally sufficient to allow the polymer precursors to react and form a polymer, for example the mixture may be aged anywhere from 1 hour to 48 hours, or more or less depending on the desired result. Typical embodiments include aging for a period of time ranging from about 2 hours to about 48 hours, for example in some embodiments aging comprises about 12 hours and in other embodiments aging comprises about 4-8 hours (e.g., about 6 hours).

In certain embodiments, an electrochemical modifier is incorporated during the above described polymerization process performed by the chemical vapor infiltration system 26 for example. For example, in some embodiments, an electrochemical modifier in the form of metal particles, metal paste, metal salt, metal oxide or molten metal can be dissolved or suspended into the mixture from which the gel resin is produced

Exemplary electrochemical modifiers for producing composite materials may fall into one or more than one of the chemical classifications. In some embodiments, the electrochemical modifier is a lithium salt, for example, but not limited to, lithium fluoride, lithium chloride, lithium carbonate, lithium hydroxide, lithium benzoate, lithium bromide, lithium formate, lithium hexafluorophosphate, lithium iodate, lithium iodide, lithium perchlorate, lithium phosphate, lithium sulfate, lithium tetraborate, lithium tetrafluoroborate, and combinations thereof.

In certain embodiments, the electrochemical modifier comprises a metal, and exemplary species includes, but are not limited to aluminum isopropoxide, manganese acetate, nickel acetate, iron acetate, tin chloride, silicon chloride, and combinations thereof. In certain embodiments, the electrochemical modifier is a phosphate compound, including but not limited to phytic acid, phosphoric acid, ammonium dihydrogen phosphate, and combinations thereof. In certain embodiments, the electrochemical modifier comprises silicon, and exemplary species includes, but are not limited to silicon powders, silicon nanotubes, polycrystalline silicon, nanocrystalline silicon, amorphous silicon, porous silicon, nano sized silicon, nano-featured silicon, nano-sized and nano-featured silicon, silicyne, and black silicon, and combinations thereof.

Electrochemical modifiers can be combined with a variety of polymer systems through either physical mixing or chemical reactions with latent (or secondary) polymer functionality. Examples of latent polymer functionality include, but are not limited to, epoxide groups, unsaturation (double and triple bonds), acid groups, alcohol groups, amine groups, basic groups. Crosslinking with latent functionality can occur via heteroatoms (e.g. vulcanization with sulfur, acid/base/ring opening reactions with phosphoric acid), reactions with organic acids or bases (described above), coordination to transition metals (including but not limited to Ti, Cr, Mn, Fe, Co, Ni, Cu, Zn, Zr, Nb, Mo, Ag, Au), ring opening or ring closing reactions (rotaxanes, spiro compounds, etc.).

Electrochemical modifiers can also be added to the polymer system through physical blending. Physical blending can include but is not limited to melt blending of polymers and/or co-polymers, the inclusion of discrete particles, chemical vapor deposition of the electrochemical modifier and co-precipitation of the electrochemical modifier and the main polymer material.

In some instances, the electrochemical modifier can be added via a metal salt solid, solution, or suspension. The metal salt solid, solution or suspension may comprise acids and/or alcohols to improve solubility of the metal salt. In yet another variation, the polymer gel (either before or after an optional drying step) is contacted with a paste comprising the electrochemical modifier. In yet another variation, the polymer gel (either before or after an optional drying step) is contacted with a metal or metal oxide sol comprising the desired electrochemical modifier.

In addition to the above exemplified electrochemical modifiers, the composite materials may comprise one or more additional forms (i.e., allotropes) of carbon. In this regard, it has been found that inclusion of different allotropes of carbon such as graphite, amorphous carbon, conductive carbon, carbon black, diamond, C60, carbon nanotubes (e.g., single and/or multi-walled), graphene and/or carbon fibers into the composite materials is effective to optimize the electrochemical properties of the composite materials. The various allotropes of carbon can be incorporated into the carbon materials during any stage of the preparation process described herein. For example, during the solution phase, during the gelation phase, during the curing phase, during the pyrolysis phase, during the milling phase, or after milling. In some embodiments, the second carbon form is incorporated into the composite material by adding the second carbon form before or during polymerization of the polymer gel as described in more detail herein. The polymerized polymer gel containing the second carbon form is then processed according to the general techniques described herein to obtain a carbon material containing a second allotrope of carbon.

In some embodiments, the polymer precursor is a polyvinilbenzene spheres produced by precipitation polymerization. In other embodiments, the polymer precursor in the low or essentially solvent free reaction mixture is a urea or an amine containing compound. For example, in some embodiments the polymer precursor is urea, melamine, hexamethylenetetramine (HMT) or combination thereof. Other embodiments include polymer precursors selected from isocyanates or other activated carbonyl compounds such as acid halides and the like.

Some embodiments of the disclosed methods include preparation of low or solvent-free polymer gels (and carbon materials) comprising electrochemical modifiers. Such electrochemical modifiers include, but are not limited to nitrogen, silicon, and sulfur. In other embodiments, the electrochemical modifier comprises fluorine, iron, tin, silicon, nickel, aluminum, zinc, or manganese. The electrochemical modifier can be included in the preparation procedure at any step. For example, in some the electrochemical modifier is admixed with the mixture, the polymer phase or the continuous phase.

The porous carbon material can be achieved via pyrolysis of a polymer produced from precursor materials as described above. In some embodiments, the porous carbon material comprises an amorphous activated carbon that is produced by pyrolysis, physical or chemical activation, or combination thereof in either a single process step or sequential process steps.

The temperature and dwell time of pyrolysis can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the pyrolysis temperature varies from 650° C. to 1100° C. The pyrolysis can be accomplished in an inert gas, for example nitrogen, or argon.

In some embodiments, an alternate gas is used to further accomplish carbon activation. In certain embodiments, pyrolysis and activation are combined. Suitable gases for accomplishing carbon activation include, but are not limited to, carbon dioxide, carbon monoxide, water (steam), air, oxygen, and further combinations thereof. The temperature and dwell time of activation can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the temperature for combined pyrolysis and activation varies from 650° C. to 1100° C.

In some embodiments, combined pyrolysis and activation is carried out to prepare the porous carbon scaffold. In such embodiments, the process gas can remain the same during processing, or the composition of process gas may be varied during processing. In some embodiments, the addition of an activation gas such as CO2, steam, or combination thereof, is added to the process gas following sufficient temperature and time to allow for pyrolysis of the solid carbon precursors.

Suitable gases for accomplishing carbon activation include, but are not limited to, carbon dioxide, carbon monoxide, water (steam), air, oxygen, and further combinations thereof. The temperature and dwell time of activation can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the activation temperature varies from 650° C. to 1100° C.

Either prior to the pyrolysis, and/or after pyrolysis, and/or after activation, the carbon may be subjected to a particle size reduction. The particle size reduction can be accomplished by a variety of techniques known in the art, for example by jet milling in the presence of various gases including air, nitrogen, argon, helium, supercritical steam, and other gases known in the art. Other particle size reduction methods, such as grinding, ball milling, jet milling, water jet milling, and other approaches known in the art are also envisioned.

The porous carbon scaffold may be in the form of particles. The particle size and particle size distribution can be measured by a variety of techniques known in the art, and can be described based on fractional volume. In this regard, the Dv50 of the carbon scaffold may be between 10 nm and 10 mm, for example between 100 nm and 1 mm, for example between 1 μm and 100 μm, for example between 2 μm and 50 μm, example between 3 μm and 30 μm, example between 4 μm and 20 μm, example between 5 μm and 10 μm. In certain embodiments, the Dv50 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv100 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv99 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the D,90 is less than 1 mm, for example less than 100 μm, for example less than 50 μm, for example less than 30 μm, for example less than 20 μm, for example less than 10 μm, for example less than 8 μm, for example less than 5 μm, for example less than 3 μm, for example less than 1 μm. In certain embodiments, the Dv0 is greater than 10 nm, for example greater than 100 nm, for example greater than 500 nm, for example greater than 1 μm, for example greater than 2 μm, for example greater than 5 μm, for example greater than 10 μm. In certain embodiments, the Dv1 is greater than 10 nm, for example greater than 100 nm, for example greater than 500 nm, for example greater than 1 μm, for example greater than 2 μm, for example greater than 5 μm, for example greater than 10 μm. In certain embodiments, the Dv10 is greater than 10 nm, for example greater than 100 nm, for example greater than 500 nm, for example greater than 1 μm, for example greater than 2 μm, for example greater than 5 μm, for example greater than 10 μm.

In some embodiments, the surface area of the porous carbon scaffold can comprise a surface area greater than 400 m²/g, for example greater than 500 m²/g, for example greater than 750 m²/g, for example greater than 1000 m²/g, for example greater than 1250 m²/g, for example greater than 1500 m²/g, for example greater than 1750 m²/g, for example greater than 2000 m²/g, for example greater than 2500 m²/g, for example greater than 3000 m²/g. In other embodiments, the surface area of the porous carbon scaffold can be less than 500 m²/g. In some embodiments, the surface area of the porous carbon scaffold is between 200 and 500 m²/g. In some embodiments, the surface area of the porous carbon scaffold is between 100 and 200 m²/g. In some embodiments, the surface area of the porous carbon scaffold is between 50 and 100 m²/g. In some embodiments, the surface area of the porous carbon scaffold is between 10 and 50 m²/g. In some embodiments, the surface area of the porous carbon scaffold can be less than 10 m²/g.

In some embodiments, the pore volume of the porous carbon scaffold is greater than 0.4 cm³/g, for example greater than 0.5 cm³/g, for example greater than 0.6 cm³/g, for example greater than 0.7 cm³/g, for example greater than 0.8 cm³/g, for example greater than 0.9 cm³/g, for example greater than 1.0 cm³/g, for example greater than 1.1 cm³/g, for example greater than 1.2 cm³/g, for example greater than 1.4 cm³/g, for example greater than 1.6 cm³/g, for example greater than 1.8 cm³/g, for example greater than 2.0 cm³/g. In other embodiments, the pore volume of the porous carbon scaffold is less than 0.5 cm3, for example between 0.1 cm³/g and 0.5 cm³/g. In certain other embodiments, the pore volume of the porous carbon scaffold is between 0.01 cm³/g and 0.1 cm³/g.

In some other embodiments, the porous carbon scaffold is an amorphous activated carbon with a pore volume between 0.2 and 2.0 cm³/g. In certain embodiments, the carbon is an amorphous activated carbon with a pore volume between 0.4 and 1.5 cm³/g. In certain embodiments, the carbon is an amorphous activated carbon with a pore volume between 0.5 and 1.2 cm³/g. In certain embodiments, the carbon is an amorphous activated carbon with a pore volume between 0.6 and 1.0 cm³/g.

In some other embodiments, the porous carbon scaffold comprises a tap density of less than 1.0 g/cm³, for example less than 0.8 g/cm³, for example less than 0.6 g/cm³, for example less than 0.5 g/cm³, for example less than 0.4 g/cm³, for example less than 0.3 g/cm³, for example less than 0.2 g/cm³, for example less than 0.1 g/cm³.

The surface functionality of the porous carbon scaffold can vary. One property which can be predictive of surface functionality is the pH of the porous carbon scaffold. The presently disclosed porous carbon scaffolds comprise pH values ranging from less than 1 to about 14, for example less than 5, from 5 to 8 or greater than 8. In some embodiments, the pH of the porous carbon is less than 4, less than 3, less than 2 or even less than 1. In other embodiments, the pH of the porous carbon is between about 5 and 6, between about 6 and 7, between about 7 and 8 or between 8 and 9 or between 9 and 10. In still other embodiments, the pH is high and the pH of the porous carbon ranges is greater than 8, greater than 9, greater than 10, greater than 11, greater than 12, or even greater than 13.

The pore volume distribution of the porous carbon scaffold can vary. For example, the % micropores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable micropore volume in the porous carbon scaffold.

The mesopores comprising the porous carbon scaffold can vary. For example, the % mesopores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable mesopore volume in the porous carbon scaffold.

In some embodiments, the pore volume distribution of the porous carbon scaffold comprises more than 50% macropores, for example more than 60% macropores, for example more than 70% macropores, for example more than 80% macropores, for example more than 90% macropores, for example more than 95% macropores, for example more than 98% macropores, for example more than 99% macropores, for example more than 99.5% macropores, for example more than 99.9% macropores.

In certain preferred embodiments, the pore volume of the porous carbon scaffold comprises a blend of micropores, mesopores, and macropores. Accordingly, in certain embodiments, the porous carbon scaffold comprises 0-20% micropores, 30-70% mesopores, and less than 10% macropores. In certain other embodiments, the porous carbon scaffold comprises 0-20% micropores, 0-20% mesopores, and 70-95% macropores. In certain other embodiments, the porous carbon scaffold comprises 20-50% micropores, 50-80% mesopores, and 0-10% macropores. In certain other embodiments, the porous carbon scaffold comprises 40-60% micropores, 40-60% mesopores, and 0-10% macropores. In certain other embodiments, the porous carbon scaffold comprises 80-95% micropores, 0-10% mesopores, and 0-10% macropores. In certain other embodiments, the porous carbon scaffold comprises 0-10% micropores, 30-50% mesopores, and 50-70% macropores. In certain other embodiments, the porous carbon scaffold comprises 0-10% micropores, 70-80% mesopores, and 0-20% macropores. In certain other embodiments, the porous carbon scaffold comprises 0-20% micropores, 70-95% mesopores, and 0-10% macropores. In certain other embodiments, the porous carbon scaffold comprises 0-10% micropores, 70-95% mesopores, and 0-20% macropores.

In certain embodiments, the % of pore volume in the porous carbon scaffold representing pores between 100 and 1000 Å (10 and 100 nm) comprises greater than 30% of the total pore volume, for example greater than 40% of the total pore volume, for example greater than 50% of the total pore volume, for example greater than 60% of the total pore volume, for example greater than 70% of the total pore volume, for example greater than 80% of the total pore volume, for example greater than 90% of the total pore volume, for example greater than 95% of the total pore volume, for example greater than 98% of the total pore volume, for example greater than 99% of the total pore volume, for example greater than 99.5% of the total pore volume, for example greater than 99.9% of the total pore volume.

In certain embodiments, the pycnometry density of the porous carbon scaffold ranges from about 1 g/cc to about 3 g/cc, for example from about 1.5 g/cc to about 2.3 g/cc. In other embodiments, the skeletal density ranges from about 1.5 cc/g to about 1.6 cc/g, from about 1.6 cc/g to about 1.7 cc/g, from about 1.7 cc/g to about 1.8 cc/g, from about 1.8 cc/g to about 1.9 cc/g, from about 1.9 cc/g to about 2.0 cc/g, from about 2.0 cc/g to about 2.1 cc/g, from about 2.1 cc/g to about 2.2 cc/g or from about 2.2 cc/g to about 2.3 cc/g, from about 2.3 cc to about 2.4 cc/g, for example from about 2.4 cc/g to about 2.5 cc/g.

In some embodiments, the carbon scaffold pore volume distribution can be described as the number or volume distribution of pores as determined as known in the art based on gas sorption analysis, for example nitrogen gas sorption analysis. In some embodiments the pore size distribution can be expressed in terms of the pore size at which a certain fraction of the total pore volume resides at or below. For example, the pore size at which 10% of the pores reside at or below can be expressed at DPv10.

The DPv10 for the porous carbon scaffold can vary, for example DPv10 can be between 0.01 nm and 100 nm, for example between 0.1 nm and 100 nm, for example between 1 nm and 100 nm, for example between 1 nm and 50 nm, for example between 1 nm and 40 nm, for example between 1 nm and 30 nm, for example between 1 nm and 10 nm, for example between 1 nm and 5 nm.

The DPv50 for the porous carbon scaffold can vary, for example DPv50 can be between 0.01 nm and 100 nm, for example between 0.1 nm and 100 nm, for example between 1 nm and 100 nm, for example between 1 nm and 50 nm, for example between 1 nm and 40 nm, for example between 1 nm and 30 nm, for example between 1 nm and 10 nm, for example between 1 nm and 5 nm. In other embodiments, the DPv50 is between 2 and 100, for example between 2 and 50, for example between 2 and 30, for example between 2 and 20, for example between 2 and 15, for example between 2 and 10.

The DPv90 for the porous carbon scaffold can vary, for example DPv90 can be between 0.01 nm and 100 nm, for example between 0.1 nm and 100 nm, for example between 1 nm and 100 nm, for example between 1 nm and 50 nm, for example between 1 nm and 50 nm, for example between 1 nm and 40 nm, for example between 1 nm and 30 nm, for example between 1 nm and 10 nm, for example between 1 nm and 5 nm. In other embodiments, the DPv50 is between 2 nm and 100 nm, for example between 2 nm and 50 nm, for example between 2 nm and 30 nm, for example between 2 nm and 20 nm, for example between 2 nm and 15 nm, for example between 2 nm and 10 nm.

In some embodiments, the DPv90 is less than 100 nm, for example less than 50 nm, for example less than 40 nm, for example less than 30 nn, for example less than 20 nm, for example less than 15 nm, for example less than 10 nm. In some embodiments, the carbon scaffold comprises a pore volume with greater than 70% micropores (and DPv90 less than 100 nm, for example DPv90 less than 50 nm, for example DPv90 less than 40 nm, for example DPv90 less than 30 nm, for example DPv90 less than 20 nm, for example DPv90 less than 15 nm, for example DPv90 less than 10 nm, for example DPv90 less than 5 nm, for example DPv90 less than 4 nm, for example DPv90 less than 3 nm. In other embodiments, the carbon scaffold comprises a pore volume with greater than 80% micropores and DPv90 less than 100 nm, for example DPv90 less than 50 nm, for example DPv90 less than 40 nm, for example DPv90 less than 30 nm, for example DPv90 less than 20 nm, for example DPv90 less than 15 nm, for example DPv90 less than 10 nm, for example DPv90 less than 5 nm, for example DPv90 less than 4 nm, for example DPv90 less than 3 nm.

The DPv99 for the porous carbon scaffold can vary, for example DPv99 can be between 0.01 nm and 1000 nm, for example between 0.1 nm and 1000 nm, for example between 1 nm and 500 nm, for example between 1 nm and 200 nm, for example between 1 nm and 150 nm, for example between 1 nm and 100 nm, for example between 1 nm and 50 nm, for example between 1 nm and 20 nm. In other embodiments, the DPv99 is between 2 nm and 500 nm, for example between 2 nm and 200 nm, for example between 2 nm and 150 nm, for example between 2 nm and 100 nm, for example between 2 nm and 50 nm, for example between 2 nm and 20 nm, for example between 2 nm and 15 nm, for example between 2 nm and 10 nm.

In certain embodiments, the carbon scaffold is modified prior to impregnation of lithium. For example, in certain embodiments, the surface of the carbon pores is functionalized for the purpose of creating a more lithiophilic surface, i.e., surface that interacts preferentially with lithium or lithium containing precursor materials, wherein said preferential interaction can manifest as preferential diffusion, deposition, adsorption of the like.

In some embodiments metal oxides are used to functionalize the porous carbon and improve lithiophilicity and thereby improve SEI stability of a lithium metal anode. In this embodiment, a porous carbon scaffold is modified with zinc oxide via a hydrothermal sol-gel synthesis reaction. Zinc acetate dihydrate is dissolved in water and stirred with micronized porous carbon powder. A strong oxidizing agent such as NaOH is then added dropwise into the reaction solution and allowed to react for up to 2 hours, before being separated by filtration and allowed to dry. In some embodiments the metal oxide may be aluminum oxide, nickel oxide, manganese oxide, cobalt oxide, tin oxide, or titanium oxide.

In still further embodiments the metal oxide is deposited via atomic layer deposition, physical vapor deposition onto the porous carbon surface and then subsequently converted to a metal oxide via chemical or thermal oxidation reactions. In still further embodiments, the porous carbon may be coated with a polymer containing lithium.

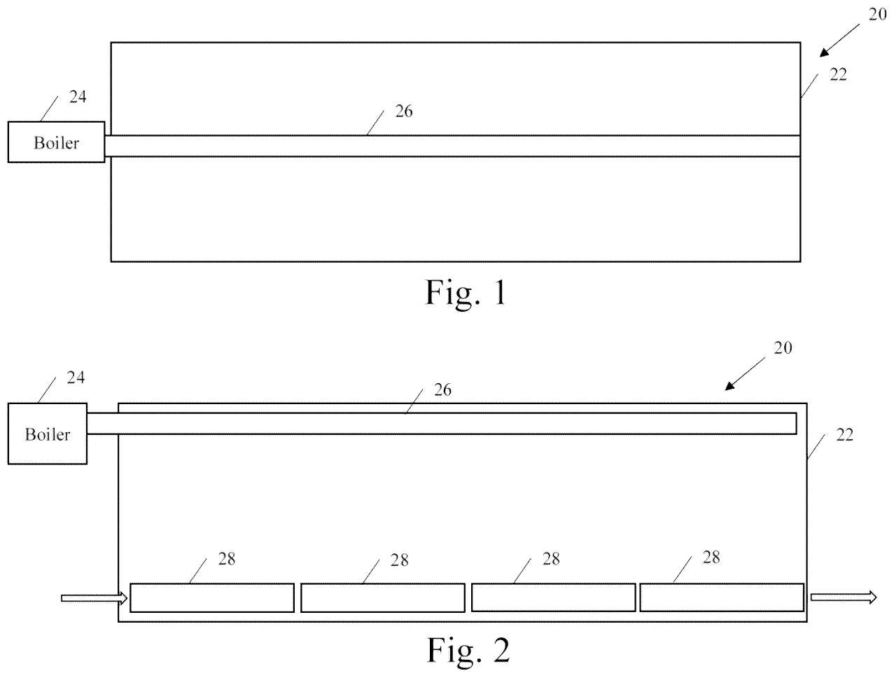

Referring to FIGS. 1 and 2, components are provided for producing the activated carbon as described above. The components include a kiln 20 that includes at least a muffle 22, and a steam sparger 26 that receives steam produced by a boiler 24. Trays 28 of pyrolyzed carbon are moved through muffle 22 via a conveyor device. The pyrolyzed carbon is exposed to steam that exits ports (i.e., holes) located in the steam sparger 26. The steam sparger 26 hangs from supports located at the top of the muffle 22. The exit ports are located in the lower half of the steam sparger 26 in order to direct steam towards the carbon located in the trays 28. The trays 28 may be transported (i.e., pushed) on rails through the lower part of the muffle 22. The muffle 22 may include parallel sets of rails of trays 28 with a dedicated steam sparger 26 located above each set of rails in order to direct steam into the trays 28 of the respective set of rails.

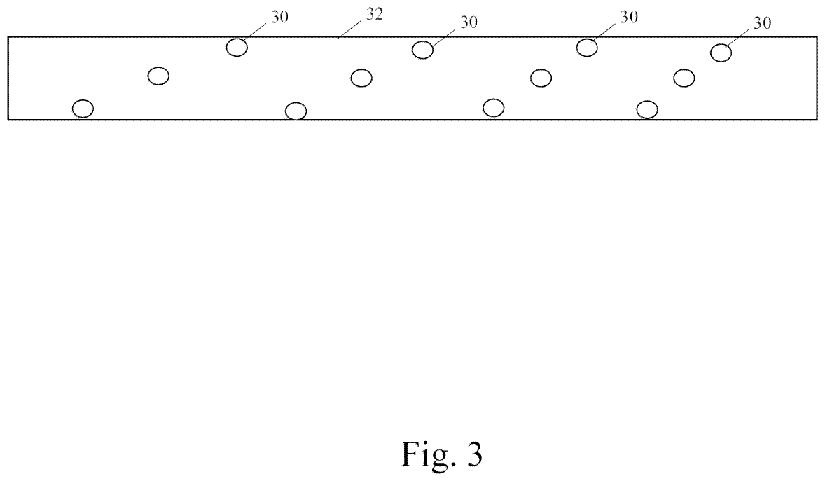

In various embodiments, as shown in FIG. 3, holes 30 that are machined/formed into the bottom half of a steam sparger 26 are spaced closer together the further away they are from the steam source (i.e., the boiler 24). Because the holes 30 are spaced further apart at a proximal end of a sparger 32 than at a distal end of the sparger 32, the amount of steam exiting the sparger 32 may be normalized along its length. This allows for more equal expulsion of steam from the sparger 26 onto the material in the trays 28.

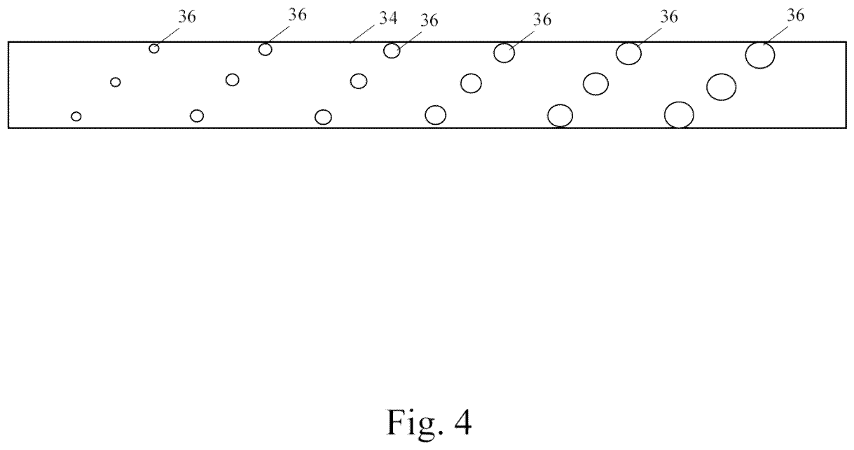

In various embodiments, as shown in FIG. 4, holes 36 that are machined into the bottom half of a steam sparger 34 are larger (i.e., greater diameter) the further away they are from the steam source (i.e., the boiler 24). Because the holes 36 are smaller at a proximal end of a sparger 34 than at a distal end of the sparger 34, the amount of steam exiting the sparger 32 may be normalized along its length. This also allows for more equal expulsion of steam from the sparger 34 onto the material in the trays 28.

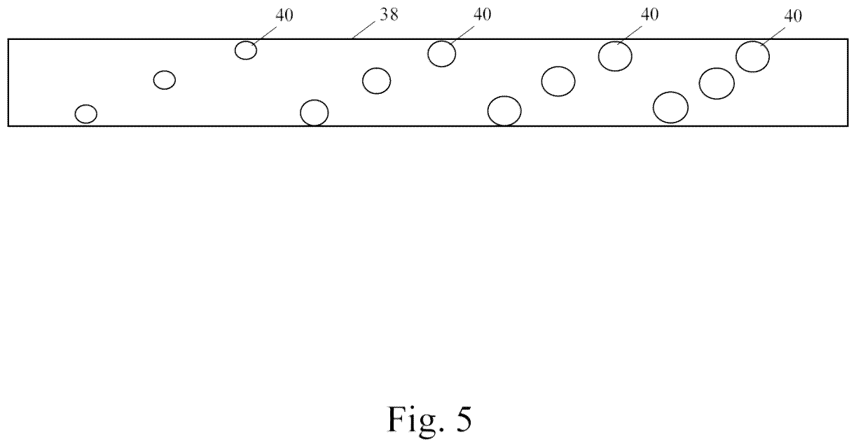

In various embodiments, as shown in FIG. 5, holes 40 that are machined into the bottom half of a steam sparger 38 are larger (i.e., greater diameter) and spaced further apart the further away the holes 40 are from the steam source (i.e., the boiler 24). Because the holes 36 are smaller at a proximal end of a sparger 38 than at a distal end of the sparger 38, the amount of steam exiting the sparger 32 may be normalized along its length. This allows for more equal expulsion of steam from the sparger 38 onto the material in the trays 28.

In various embodiments, the steam spargers 26, 32, 34, 38 may be cylindrical and the holes 30, 36, 40 may be formed by machining into the steam spargers 26, 32, 34, 38 at roughly perpendicular to the surface. As such, FIGS. 3-5 are not visually accurate because they fail to show the curvature of the steam spargers 26, 32, 34, 38. One or ordinary skill would understand how holes would appear around a cylinder when viewed in a two-dimensional image. The figures are presented to show different dynamics of the holes (i.e., position, size).

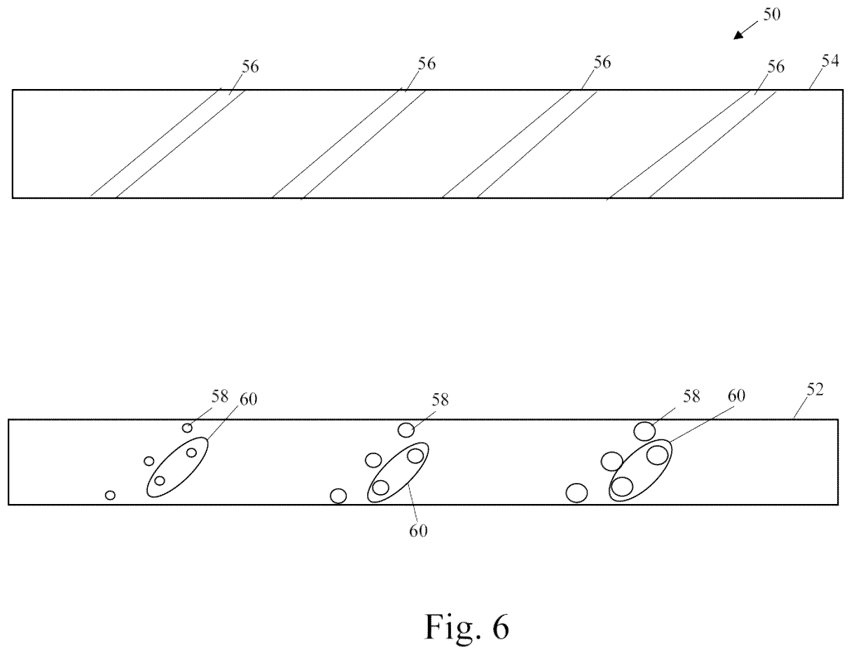

In various embodiments, as shown in FIG. 6, a steam sparger 50 may include an inner tube 52 and an outer tube 54. The outer tube 54 includes a spiral slot 56. The inner tube 52 includes multiple hole patterns 58, 60. When either the inner tube 52 or the outer tube 54 is rotated relative to each other, the different hole patterns are exposed by the spiral slot 56. Thus, during a run of material through a kiln the amount of steam directed at the material may be dynamically altered. Sensors (not shown) within the muffle may provide indications as to the real-time amount of steam being applied to the material at multiple locations within the muffle. The rotation of the tubes 52, 54 may be manually or automatically altered to change the amount of applied steam based on the steam indications provided by the sensors, thereby allowing an operator to fine tune steam flow throughout a kiln.

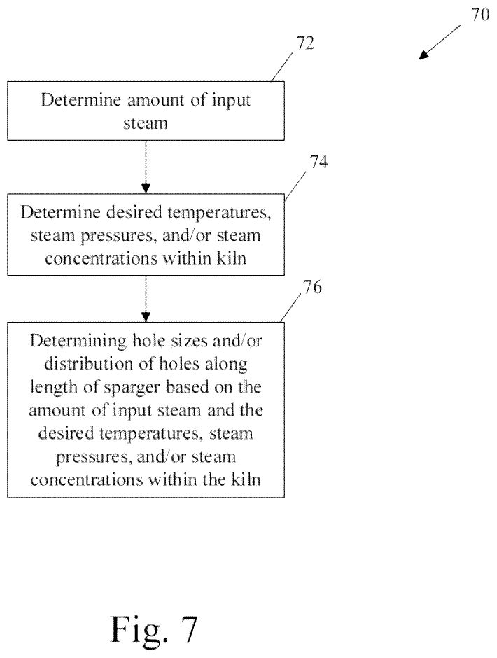

Referring to FIG. 7, a method 70 is provided for determining desired patterns/sizes for the holes of a steam sparger. At a block 72, an amount of input steam to the steam sparger is determined. At a block 74, one determines temperatures, steam pressures, and/or steam quantities desired at target material locations within the kiln/muffle. At a block 66, hole sizes and/or distribution of holes along length of the sparger are determined based on the amount of input steam and the desired temperatures, steam pressures, and/or steam quantities (i.e., flow rate, concentration) within the kiln. The size and spacing between the holes may be calculated using various methods, e.g., Navier-Stokes equation, Fourier transforms, in order to optimize steam outputted into the muffle and onto target material located on trays. An example of optimized steam output is where steam pressure and/or quantity of steam that comes in contact with the target material within the trays is equal or varies by less than a predefined threshold amount at all tray and/or target material locations within the muffle (i.e., at the proximal end nearest a boiler and at the distal end furthest away from the boiler).

### Expressed Embodiments

Embodiment 1. A kiln system comprising a muffle, a boiler, a steam sparger coupled to the boiler and located with the muffle, wherein the steam sparger is configured produce steam flow at a proximal end that is within a threshold amount of steam flow at a distal end, and a material introduction device configured to move material from a proximal end to a distal of the muffle, the material introduction device located a predefined distance from the steam sparger.

Embodiment 2. The system of the foregoing Embodiment, wherein the steam sparger comprises holes that are spaced further apart at the distal end than at the proximal end.

Embodiment 3. The system of the foregoing Embodiments, wherein the steam sparger comprises holes that are larger at the distal end than at the proximal end.

Embodiment 4. The system of Embodiment 3, wherein the holes have a greater diameter at the distal end than at the proximal end.

Embodiment 5. The system of the foregoing Embodiments, wherein the steam sparger comprises holes that are spaced further apart at the distal end than at the proximal end and are larger at the distal end than at the proximal end.

Embodiment 6. The system of the foregoing Embodiments, wherein the steam sparger comprises holes that are adjustable in at least one of size or spacing.

Embodiment 7. The system of Embodiment 6, further comprising at least one sensor configured to determine an amount of steam outputted by the steam sparger and a controller configured to automatically adjust at least one of size or spacing of the holes based on the determined amount of steam outputted by the steam sparger.

Embodiment 8. A muffle device comprising a steam sparger configured to receive steam from a boiler, wherein the steam sparger is configured to produce steam flow at a proximal end that is within a threshold amount of steam flow at a distal end and a material introduction device configured to move material from a proximal end to a distal of the muffle device, the material introduction device located a predefined distance from the steam sparger.

Embodiment 9. The device of the foregoing Embodiment, wherein the steam sparger comprises holes that are spaced further apart at the distal end than at the proximal end.

Embodiment 10. The device of the foregoing Embodiments, wherein the steam sparger comprises holes that are larger at the distal end than at the proximal end.

Embodiment 11. The device of Embodiment 10, wherein the holes have a greater diameter at the distal end than at the proximal end.

Embodiment 12. The device of the foregoing Embodiments, wherein the steam sparger comprises holes that are spaced further apart at the distal end than at the proximal end and are larger at the distal end than at the proximal end.

Embodiment 13. The device of the foregoing Embodiments, wherein the steam sparger comprises holes that are adjustable in at least one of size or spacing.

Embodiment 14. The device of Embodiment 13, further comprising at least one sensor configured to determine an amount of steam outputted by the steam sparger and a controller configured to automatically adjust at least one of size or spacing of the holes based on the determined amount of steam outputted by the steam sparger.

Embodiment 15. An activated carbon generating system comprising a kiln configured to produced activated carbon material, the kiln comprising a muffle, a boiler, a steam sparger coupled to the boiler and located with the muffle, wherein the steam sparger is configured to produce steam flow at a proximal end that is within a threshold amount of steam flow at a distal end, and a carbon material transport device configured to move pyrolyzed carbon material from a proximal end to a distal of the muffle, the carbon material introduction device located a predefined distance from the steam sparger.

Embodiment 16. The system of the foregoing Embodiment, wherein the steam sparger comprises holes that are spaced further apart at the distal end than at the proximal end.

Embodiment 17. The system of the foregoing Embodiments, wherein the steam sparger comprises holes that are larger at the distal end than at the proximal end.

Embodiment 18. The system of Embodiment 17, wherein the holes have a greater diameter at the distal end than at the proximal end.

Embodiment 19. The system of the foregoing Embodiments, wherein the steam sparger comprises holes that are spaced further apart at the distal end than at the proximal end and are larger at the distal end than at the proximal end.

Embodiment 20. The system of the foregoing Embodiments, wherein the steam sparger comprises holes that are adjustable in at least one of size or spacing.

Embodiment 21. The system of Embodiment 20, further comprising at least one sensor configured to determine an amount of steam outputted by the steam sparger and a controller configured to automatically adjust at least one of size or spacing of the holes based on the determined amount of steam outputted by the steam sparger.

From the foregoing it will be appreciated that, although specific embodiments of the disclosure have been described herein for purposes of illustration, various modifications may be made without deviating from the spirit and scope of the disclosure.

1. A kiln system comprising:
a muffle;
a boiler;
a steam sparger coupled to the boiler and located with the muffle, wherein the steam sparger is configured to produce steam flow at a proximal end that is within a threshold amount of steam flow at a distal end; and
a material introduction device configured to move material from a proximal end to a distal of the muffle, the material introduction device located a predefined distance from the steam sparger.

2. The system of claim 1, wherein the steam sparger comprises holes that are spaced further apart at the distal end than at the proximal end.

3. The system of claim 1, wherein the steam sparger comprises holes that are larger at the distal end than at the proximal end.

4. The system of claim 3, wherein the holes have a greater diameter at the distal end than at the proximal end.

5. The system of claim 1, wherein the steam sparger comprises holes that are spaced further apart at the distal end than at the proximal end and are larger at the distal end than at the proximal end.

6. The system of claim 1, wherein the steam sparger comprises holes that are adjustable in at least one of size or spacing.

7. The system of claim 6, further comprising:
at least one sensor configured to determine an amount of steam outputted by the steam sparger; and
a controller configured to automatically adjust at least one of size or spacing of the holes based on the determined amount of steam outputted by the steam sparger.

8. A muffle device comprising:
a steam sparger configured to receive steam from a boiler, wherein the steam sparger is configured to produce steam flow at a proximal end that is within a threshold amount of steam flow at a distal end; and
a material introduction device configured to move material from a proximal end to a distal of the muffle device, the material introduction device located a predefined distance from the steam sparger.

9. The device of claim 8, wherein the steam sparger comprises holes that are spaced further apart at the distal end than at the proximal end.

10. The device of claim 8, wherein the steam sparger comprises holes that are larger at the distal end than at the proximal end.

11. The device of claim 10, wherein the holes have a greater diameter at the distal end than at the proximal end.

12. The device of claim 8, wherein the steam sparger comprises holes that are spaced further apart at the distal end than at the proximal end and are larger at the distal end than at the proximal end.

13. The device of claim 8, wherein the steam sparger comprises holes that are adjustable in at least one of size or spacing.

14. The device of claim 13, further comprising:
at least one sensor configured to determine an amount of steam outputted by the steam sparger; and
a controller configured to automatically adjust at least one of size or spacing of the holes based on the determined amount of steam outputted by the steam sparger.

15. An activated carbon generating system comprising:
a kiln configured to produced activated carbon material, the kiln comprising:
a muffle;
a boiler;
a steam sparger coupled to the boiler and located with the muffle, wherein the steam sparger is configured to produce steam flow at a proximal end that is within a threshold amount of steam flow at a distal end; and
a carbon material transport device configured to move pyrolyzed carbon material from a proximal end to a distal of the muffle, the carbon material transport device located a predefined distance from the steam sparger.

16. (Original The system of claim 15, wherein the steam sparger comprises holes that are spaced further apart at the distal end than at the proximal end.

17. The system of claim 15, wherein the steam sparger comprises holes that are larger at the distal end than at the proximal end.

18. The system of claim 17, wherein the holes have a greater diameter at the distal end than at the proximal end.

19. The system of claim 15, wherein the steam sparger comprises holes that are spaced further apart at the distal end than at the proximal end and are larger at the distal end than at the proximal end.

20. The system of claim 15, wherein the steam sparger comprises holes that are adjustable in at least one of size or spacing.

21. The system of claim 20, further comprising:
at least one sensor configured to determine an amount of steam outputted by the steam sparger; and
a controller configured to automatically adjust at least one of size or spacing of the holes based on the determined amount of steam outputted by the steam sparger.
